(19) United States
(12) Patent Application Publication
(10) Pub. No.: US 2009/0050074 A1
(43) Pub. Date: Feb. 26, 2009

(54) Perfect pocket trainer

(76) Inventor: Lorel Lynn Molder, Dunnellon, FL (US)

Correspondence Address: Lorel Lynn Molder, 9551 S.E. Levy County Rd. 337, Dunnellon, FL, 34431, US

(21) Appl. No.: 11/895,006

(22) Filed: Aug. 22, 2007

(51) Int. Cl. A01K 15/04

(52) U.S. Cl. 119/712

(57) ABSTRACT

Perfect pocket training and practice device is a circular stand of a desirable circumference representative of the perfect pocket of a turn around barrels, poles or other course markers used for performance horse racing competition. The stand comprises an impact resistant material that is light in weight to relent more safely to impact and relative in the structured height for safe visibility of both horse and rider. The device simplifies more safely training and practice methods for children, youth and adults beginning competition as well as experienced competitors and trainers.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This invention relates to a simplified device to assist in training and practicing patterns in horse competitions. Specifically horses and riders being trained for barrel racing, pole bending and other related speed performance events.

In barrel racing, pole bending and other speed event competition, contestants compete for the fastest time running specific patterns. The pattern to be executed is laid out by markers for the various speed events such as barrels, poles and cones.

Barrel racing competition courses are laid out in a triangular cloverleaf pattern around three barrels. The horse and rider are allowed a running start and time begins and ends upon crossing a visible starting line. Touching a barrel is permitted, but a five second penalty is assessed for knocking over a barrel.

The pattern can be started either from the left or right and contestants who go off the prescribed course are disqualified. The rider can choose to start on either of the front two barrels. A pattern that starts with the right hand turn around the right hand barrel must be followed by two left hand turns around the remaining two barrels in the course. A rider who chooses to go left first must make two right hand turns for the second and third barrel. Either start produces the desired cloverleaf pattern. Clearly knocking over a barrel is disastrous in a race that may take as little as fifteen seconds. The times for running the course are measured in split seconds for winning and placing in the event.

Because the distance the horse runs to complete the cloverleaf pattern is a significant factor in obtaining the fastest time, the rider urges the horse to come as close to each barrel as possible without knocking the barrel over. As a result, it is not uncommon for the leg of the rider or the body of the horse to contact one or more of the barrels in completing the cloverleaf pattern.

The impact of the human leg with the barrel can result in injury to the rider. The injury can be exacerbated because the rider's leg may be held against the body of the horse. As such, the total mass contacting the barrel can be a combined mass of the rider's leg and a portion of the mass of the horse. This combined mass having a velocity equal to speed at which the horse is running at the time of contact with the barrel can generate a large amount of impact force incident upon the rider's leg.

As such, riders may desire to wear protective leg gear, such as shin guards during practice training or competition to prevent or minimize injury from contact or impact with the barrel. While protective gear may reduce or minimize rider injury, the knocked over barrels remain a significant problem during practice and training. If the rider is practicing or training without an assistant, the rider must dismount and set up the barrels before each practice run.

Trainers and contestants often train and practice with use of cones to direct the horse around the barrel into a desired pocket for the turn. This training and practice aid manifests two undesired problems. The first and most significant problem with use of the cones as an aid is that it tends to develop a squaring of the turn into and out of the pocket in the horse's thinking rhythm and habit formation. Obviously when the training aid is removed the squaring or diving habit is going to cause more barrel contact and more barrels knocked down. The second problem with using cones as a training aid is that the horse will very quickly reason they can be bumped or knocked out of the way with no real consequence.

Another training and practice method most frequently used by riders is to walk or trot the horse repeatedly through the desired pattern. This both allows the rider time to practice driving and reining skill and by repetition develops in the horse's thought rhythm a desired turning habit. Unfortunately the walking or trotting motion rhythm or thought rhythm is not the same as the running motion rhythm or thought rhythm of the horse thereby rendering little or no viable training or practice for the horse.

Pole Bending competition contestants compete for the fastest time in running through a line of six poles equally spaced between, requiring the execution of one hundred-eighty degree turns around the end poles and alternately weaving through the inner poles to complete the pattern. The horse and rider are allowed a running start and time begins and ends upon crossing a visible starting line. Touching a pole is allowed, but a five second penalty is assessed for each pole knocked over. Clearly, knocking over a pole is disastrous in a race that may take as little as nineteen seconds from start to finish. Winning and placing times in this event are split seconds apart.

The pattern may be started from either the left or right, and contestants who go off course are disqualified. A pattern that starts, for example, with the right requires the rider to run the horse straight to the far end pole, execute a left turn around the pole and than weave through the inner poles in the course back to and around the opposite end pole. Another one hundred eighty degree turn around this pole and weave in and out through the inner poles back to and around the far end pole. To complete the course the rider must drive the horse straight back across the finish line.

Again, the distance the horse runs to complete the pole bending course is a very significant factor in obtaining the fastest time. The rider will urge the horse to turn around the end poles and weave through the inner poles as close to the pole as is possible to minimize the distance the horse must run between start and finish of the course. The rider must master the driving and reining skills to run this course successfully and without knocking down any poles.

Trainers and riders will sometimes use a tire placed around the base of the pole to aid the horse in finding the desired pocket around the pole. The use of this aid as a training and practice presents two very significant dangers to both horse and rider. The first and the foremost danger is that the horse can misstep into inner circle of tire. This could injure the horse's ankle or leg as well as possibly causing the horse to fall both injuring horse and rider. The visibility of the tire for the horse is not very great and simply not seeing it clearly is another significant factor of danger to the horse. The harshness of the tires' mass could cause injury to the horse's foot merely by striking the tire at running speed. This impact could also cause the horse to stumble and fall. The danger and risk factors of using tires as a training and practice aid should forewarn even the skilled rider it is not the most acceptable method.

Significant problems in the pole bending training and practice for beginning riders such as basic horse handling skills and the coordination to apply driving and reining direction to the horse at running speed reduces practice and training to walking or trotting the course. The use of cones to develop the pocket for turning has little or no effect for the motion habit of the horse and actually hinders the concentration of a beginning rider.

### BRIEF SUMMARY OF THE INVENTION

The present invention provides a safer more simplified solution in addressing a means of training and practice of pattern performance horses.

Accordingly, besides the training objects and advantages of devices described in my patent, several objects and advantages of the present invention are:
(a) To simplify the method of teaching horses the correct turning pattern around objects intended as marker.
(b) To provide a training-practice device suitable to safely assist novice and beginning
(c) competitors as well as skilled trainers.
(d) To provide a device which will embed in the horse's thought rhythm a radial turning pocket around markers.
(e) To provide a device that directs a turning pocket for the horse that is exact.
(f) To provide a training device that directs the horse around the marker and avoids knocking it down.
(g) To provide a training device that reduces required driving or steering skills of the rider.
(h) To provide a training device that is both durable and people as well as horse friendly.

Further objects and advantages are to provide a device that can assist even the youngest child in the competitions with successful practices.

### BRIEF DESCRIPTION OF THE SEVERAL VIEWS OF THE DRAWING

In the drawings closely related figures have the same number, but different alphabetical suffixes. Identical pieces used typically in the drawings have the same numerical identification.

FIGS. 1A and 1B show various aspects of the device, a top or plan view, and a side view.

FIG. 1C illustrates application of the device to teach the correctness in the turn around the barrel.

FIG. 1D illustrates application of the device to teach the correctness in the turn around the pole.

FIG. 2A illustrates utilization of a tire to develop the turn around the barrel.

FIG. 2B illustrates utilization of a tire to develop the turn around the pole.

FIG. 3A illustrates utilization of cones to develop the turn around the barrel.

FIG. 3B illustrates utilization of cones to develop the turn around the pole.

FIG. 4 show assembly positions of components of the invention designated numerically.

### REFERENCE NUMERALS IN DRAWINGS

5. Rails 7. Post

6. T's 8. Set Screw

### DETAILED DESCRIPTION OF THE INVENTION

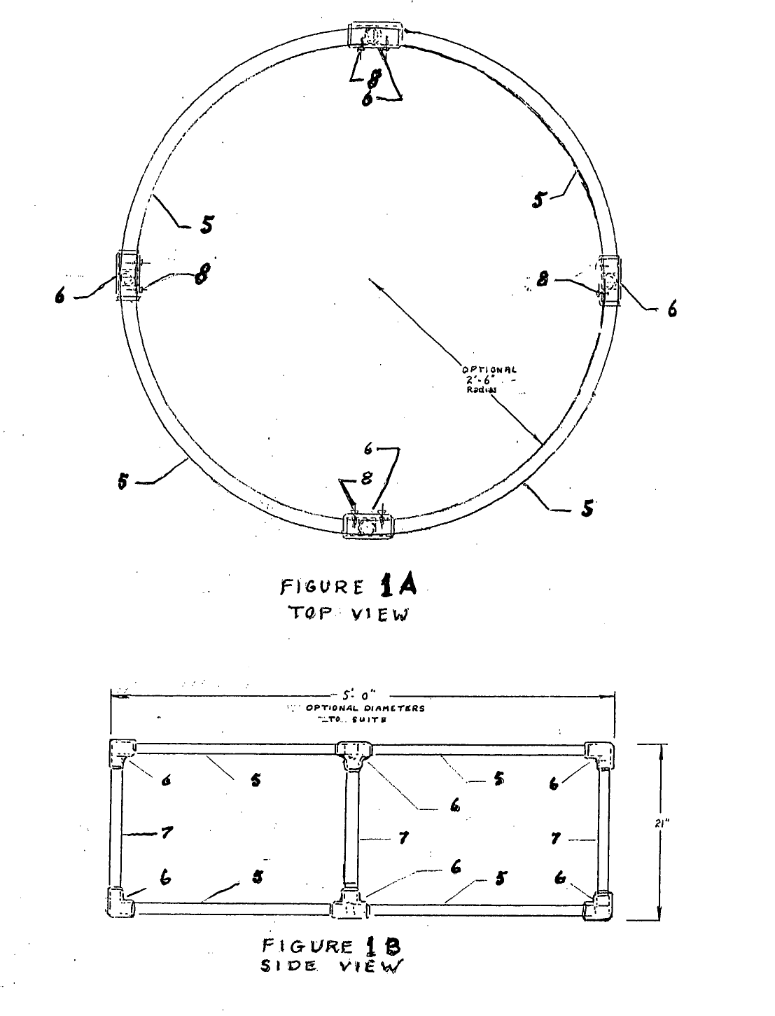

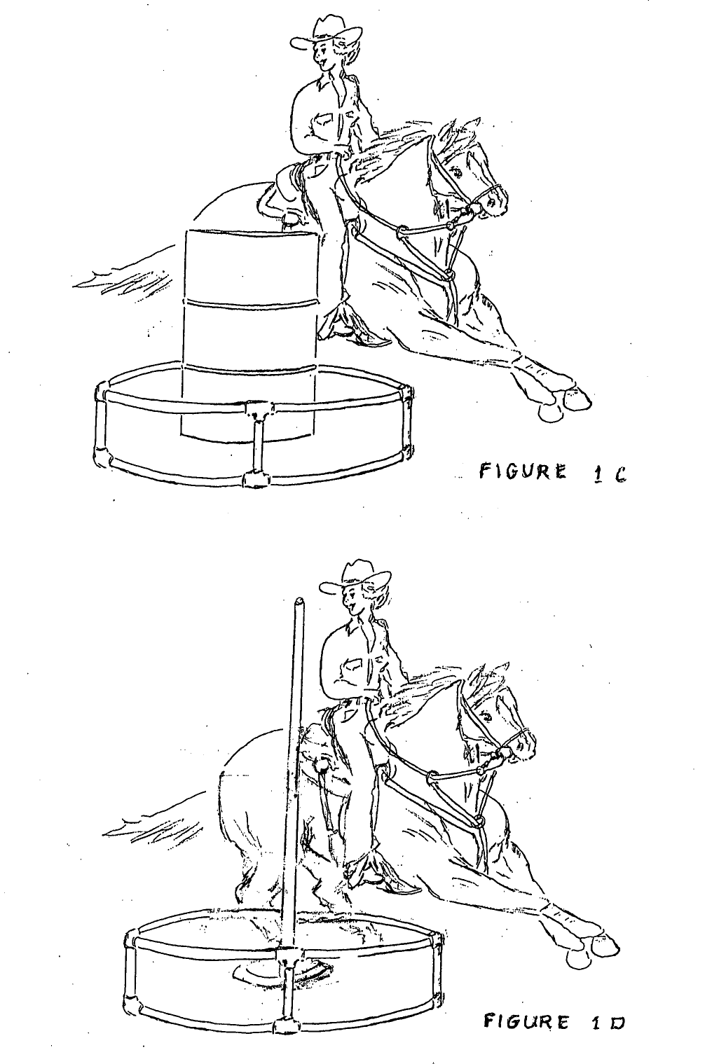

A typical embodiment of the present invention is illustrated in FIGS. 1A (top view) and 1B ( side view). The enclosure has a rail base which enfolds into T's that embody the post. The top of the post is embodied by the T's which enfolds the top rails completing the circular enclosure. Drawing Numerals 5 thru 8 illustrates the assembly parts typical to this invention. The encirclement enfolds the #5 rails into #6 T's to form base and top enclosures supported and connected #7 posts enfolded into #6T's which embody #5 rails forming the top of the circular enclosure. The entirety of parts 5 thru 7 are furniture grade PVC and #5 rails are secured in the enfoldment with #8 set screws.

FIG. 1C illustrates typically the utilization of this invention by the rider and horse to perfect the pocket when training and practicing the essential turns around the barrels for the barrel racing pattern.

FIG. 1D illustrates training and practicing perfecting the pocket for turning around the pole with the rider using this invention to aid the horse's understanding the desired motion pattern for pole bending racing.

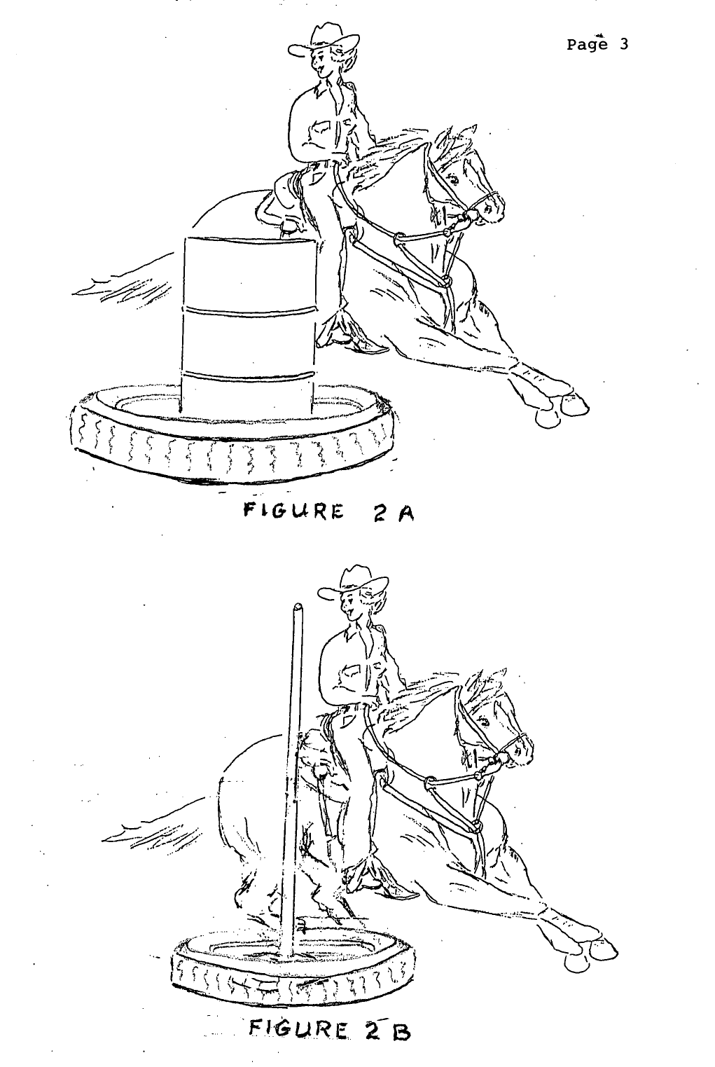

FIG. 2A illustrates the rider using a large tire to attempt to aid the horse in perfecting a turning pocket. This device as a practice and training aid develops a series of dangers and risks to both rider and horse. The common low profile of a tire presents visibility hazard for the horse and rider as well. The horse could easily step inside the rim of the tire injuring the horse's foot and possibly causing the horse to fall. Such an accident could cause serious injuries to the rider and the horse. The mass of the tire makes it somewhat immovable as far as impact with the horse's foot and this could cause serious injury to the horse and perhaps stumble and fall

FIG. 2B illustrates the rider using a tire to aid training and practice methods in development of the turning pocket around the pole for the horse. This Figure clearly illustrates the manifold of safety defects to both horse and rider in using the tire as a pocket training aid. Visibility is not within the vision perimeter of the rider and due to the low profile is slight within the vision perimeter of the horse as the turning pocket around pole develops in the motion pattern. This reflects the vulnerability of the horse's misstep striking the tire or actually stepping into the inner rim of the tire causing injury to the horse or the horse to fall and endangering the rider.

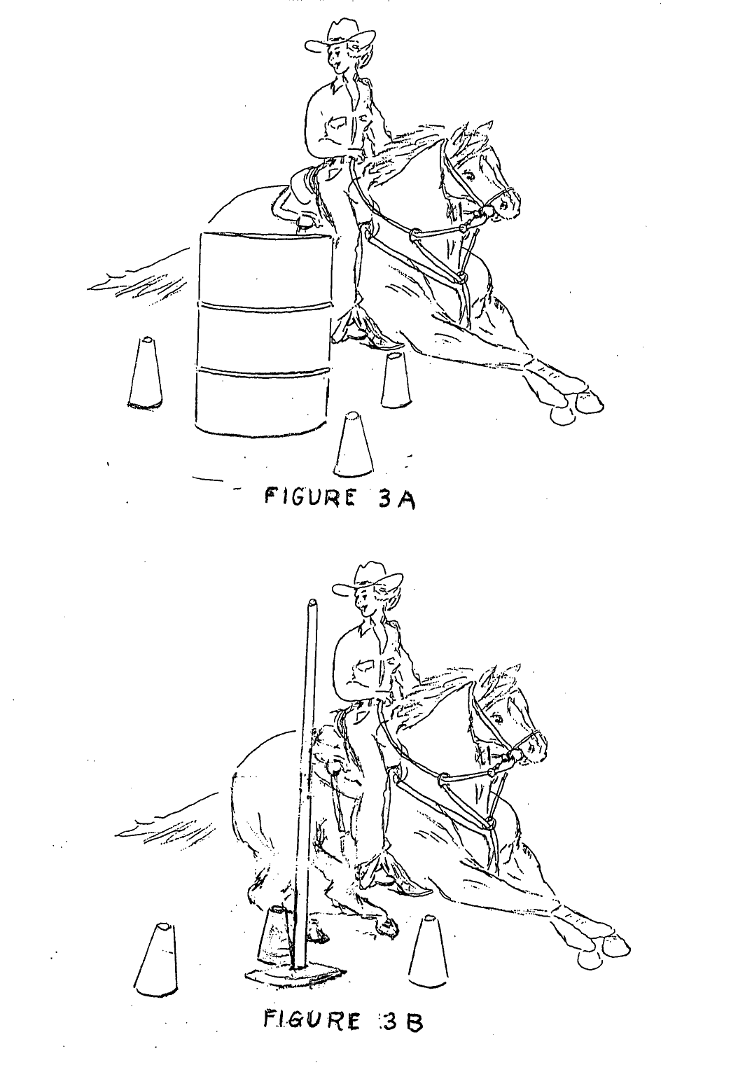

FIG. 3A illustrates the use of cones to configure a turning pocket of sort around a barrel in the training and practice of barrel racing horses. It is teaching the horse to square the turn instead of developing a perfect circular turn around the barrel in the horse's motion rhythm habit. Another significant factor in using cones as a training and practice aid is in that a cone can be knocked down even more easily than a barrel and becomes of little consequence in the horse's thinking rhythm.

FIG. 3B illustrates the rider using cones as a training and practice aid for developing a turning pocket around the pole in the pole bending race. The cones more aptly teach the horse to square the turn and effect a sort of diving turn in the motion rhythm which will more often than not result in the horse knocking down the pole.

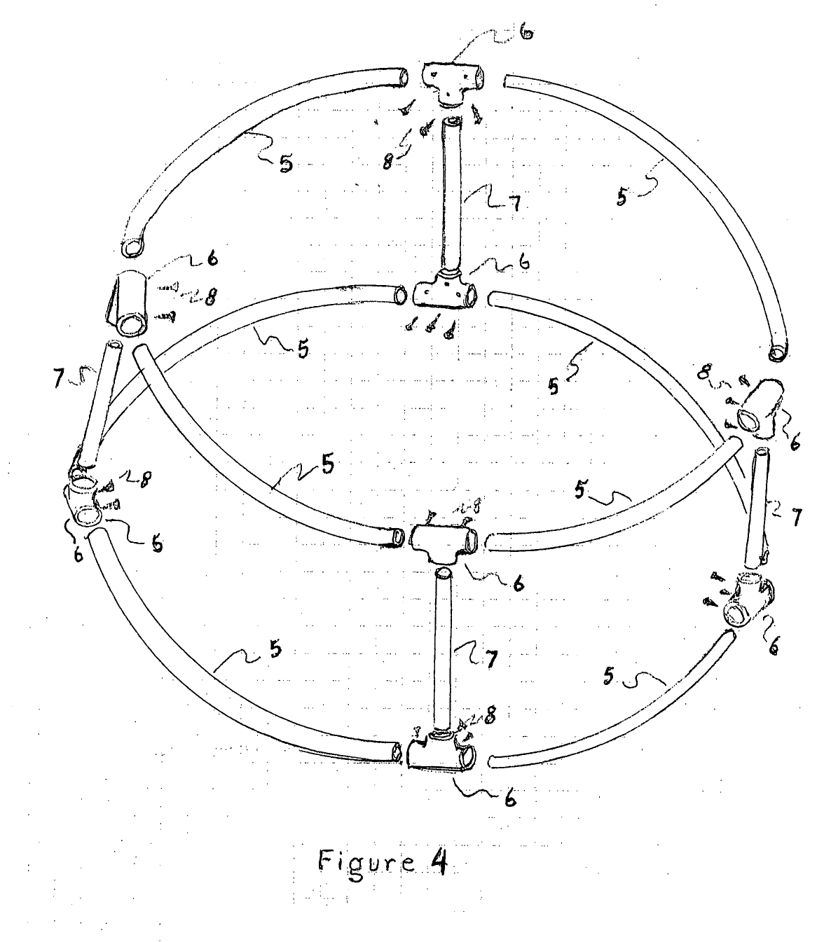

A typical assembling of the structure of this invention is illustrated in FIG. 4. The PVC rails slip easily into the lateral enfoldment of the PVC T's and are secured with set screws. Assembling four rails and four T's completes the circular embodiment of the top and bottom railings. The posts are slipped into the inverted vertical enfoldment of the T's and may be secured by either glue or with set screws. The set screws are positioned on the inner side of the T and rail embodiment as well as the T and post vertical enfoldment.

From the descriptions above, a number of advantages of this invention become evident.
(a) This invention is a safer training device that clearly scribes a distinct turning pocket for the horse to turn around various markers used in speed racing competitions to achieve a motion rhythm habit in training and practice for barrel racing, pole bending, and most speed events..
(b) Although the PVC rails, T's and Posts are impact resistant, the light weight of PVC and the design of this invention permits the mass of a horse's leg even at full running speed to bump the device with unlikeliness of injury or interruption of stride.
(c) Using the Perfect Pocket Trainer for training and practice requires less driving and reining skills to practice the turns needed to achieve winning times for various speed competitions.
(d) Children and adults alike must begin learning these racing patterns by the same practice repetition as the development of the horse's motion rhythm habit and fusion into a thought rhythm. Thereby using this invention to train and practice, children as well as adults can more easily and safely learn driving and the reining skills for these competitions.
(e) The excellent visibility of this invention establishes the turning pocket clearly in the vision of both the horse and rider and permits more relaxed reining and driving skill in the practice and training for both horse and rider performance.
(f) This invention directs the horse's run pattern into a smooth rounded turn around objects used as markers in the various racing courses. Wherein other aids may create squaring or diving turns in the horse's motion rhythm habit. Square or diving turns can unseat the rider and presents another safety issue in the use of some training and practice aids.
(g) This invention may be used as a device to train and practice development of the perfect pocket for turning around barrels or poles and effectively any marker for any pattern desired in speed competitions. The light weight of the PVC structure permits ease in transferring the device from barrels to poles or other pattern markers for training and practicing various speed performance patterns.
(h) Use of the perfect pocket trainer in training and practice eliminates most of the knocked down pattern markers. More effective training and practice may be accomplished with less down time.
(i) This training and practice device is not confusing to the horse's thinking rhythm and may be easier for the horse to understand the desired perfect turning pocket.
(j) Using this training and practice device even a child may more safely and effectively learn the skills of driving and reining the horse through the racing patterns.

What I claim as my invention is:

1. A training and practice device of the type comprising a formed circular body of material having vertical corresponding interfacement comprising an upper circular body of material

2. the training and practice device of claim 1. wherein said body of material is composed but not limited to polyvinyl chloride (pvc)

3. the training and practice device of claim 2. wherein said body of material is composed, but not limited to two inch pipe preformed for the circular embodiment

4. the training and practice device of claim 3. wherein said body supports a vertical aperture that embodies longitudinal bodies of material composed of but not limited to polyvinyl chloride (pvc)

5. the training and practice device of claim 3. wherein said body of material forms a circular base with longitudinal embodiments

6. the embodiment of claim 5. wherein said body of material is interfaced with the inverted aperture which embodies the longitudinal members of embodiment of claim 5.

7. the training and practice device of claim 1. wherein said body of material is composed of but not limited to polyvinyl chloride (pvc) and secured at all joinments of said embodiment with but not limited to set screws

8. the aperture of claim 4 is a body of material structuring the embodiment of three bodies of materials and is composed but not limited to polyvinyl chloride (pvc)

9. the training and practice device of claim 1. wherein said body of material is composed of but not limited to material of white coloring.
